(19) United States
(12) Patent Application Publication
(10) Pub. No.: US 2026/0312463 A1
(43) Pub. Date: Oct. 8, 2026

(54) ECO-FRIENDLY GENERATOR USING DOULY-FED ACTIVELY DRIVEN MULTI-PHASE WINDING

(71) Applicant: M-Waves Co. Ltd., Ansan-si (KR)

(72) Inventor: Nam Soo Myung, Seongnam-si (KR)

(21) Appl. No.: 19/466,485

(22) Filed: Feb. 1, 2026

Related U.S. Application Data
(63) Continuation of application No. PCT/KR2024/011105, filed on Jul. 30, 2024.

(30) Foreign Application Priority Data
Aug. 1, 2023 (KR) 10-2023-0100666

(51) Int. Cl. H02K 7/18

(52) U.S. Cl. CPC H02K 7/1876

(57) ABSTRACT

Disclosed is a linear generator in which an electric machine independently controlling a stator and a mover having multi-phase windings is integrated with a free-piston engine (FPE) internal combustion engine. The linear generator has a relatively simple structure in terms of mechanical aspects, thereby providing high reliability and durability, and realizes an eco-friendly generator having very high fuel/energy efficiency relative to weight and volume as well as high output. In addition, the electric machine can implement strong spring and damper functions, thereby realizing an eco-friendly generator that does not require a separate physical spring and damper.

### CROSS-REFERENCE TO RELATED APPLICATION

This application is a bypass continuation application of International Patent Application No. PCT/KR2024/011105, filed on Jul. 30, 2024, which is based on and claims the benefit of priority to Korean Patent Application No. 10-2023-0100666, filed on Aug. 1, 2023, the disclosures of which are hereby incorporated by reference in their entireties.

### TECHNICAL FIELD

The present invention relates to an eco-friendly generator. More specifically, the present invention relates to an eco-friendly generator equipped with a linear generator combining an electric machine, in which both a stator and a mover are composed of multi-phase windings, with a Free-Piston Engine (FPE) internal combustion engine, the eco-friendly generator having a high-output, high-efficiency electric machine and an internal combustion engine utilizing eco-friendly fuel.

### BACKGROUD

While a prime mover type engine consists of a piston-crank to obtain output, a Free Piston Engine (FPE) is an internal combustion engine that has no restriction on the mechanical connection of a piston by a crank. Since the FPE does not have a crank that constrains the movement of the piston, mechanical friction loss is small. In addition, since the FPE can freely adjust a piston compression ratio, it can convert chemical energy into electrical energy with higher efficiency compared to a rotary motion automotive engine. Furthermore, the FPE can operate as an eco-friendly generator using various energy sources (fuels) such as compressed air, bio-fuel (alcohol), hydrogen, and gasoline.

However, conventional linear alternators mainly use a motor using a permanent magnet as a generator, and such a motor using a permanent magnet has a limit in output. In addition, such linear alternators require additional mechanical structures such as springs and dampers, which increases mechanical complexity and leads to problems of increased weight and volume.

### SUMMARY

An object of the present invention for solving the above problems is to provide a high-efficiency eco-friendly generator by fusing an internal combustion engine with a generator/motor that actively drives a stator and a mover having multi-phase windings.

As an embodiment for achieving the above object, a linear generator according to an embodiment of the present invention comprises: an electric machine comprising a stator including multi-phase windings, a mover including multi-phase windings and spaced apart from the stator by a predetermined interval, and a controller configured to independently control a first magnetic field of the stator and a second magnetic field of the mover, wherein the controller independently controls the first magnetic field and the second magnetic field so that the first magnetic field of the stator and the second magnetic field of the mover are mutually locked to each other; and an internal combustion engine comprising at least one cylinder, at least one piston coaxially aligned with the cylinder and moving freely within the cylinder, and at least one combustion chamber defined by the piston and the cylinder to combust fuel.

The following effects are expected through the technical solution above.

The eco-friendly generator according to the present invention is implemented by fusing an FPE with a generator/motor that actively drives a stator and a mover having multi-phase windings. This eco-friendly generator has a relatively simple structure in terms of mechanical aspects, resulting in high reliability and durability, and implements an eco-friendly generator having very high output and energy conversion efficiency relative to weight and volume. In addition, the eco-friendly generator according to the present invention has a high energy yield and can be implemented with a wide energy harvesting range. The electric machine can electronically generate repulsive forces and damping forces and implement strong spring and damper functions by adjusting the phase and amplitude of currents applied to the stator and the mover according to the piston position and velocity. The damping forces can be variably applied during compression and expansion strokes by controlling electromagnetic resistance, thereby realizing an eco-friendly generator that does not require separate physical springs and dampers.

### BRIEF DESCRIPTION OF THE DRAWINGS

FIG. 1 is a block diagram of a linear motor among electric machines according to an embodiment of the present invention.

FIG. 2 is a first schematic conceptual view of a generator utilizing an electric machine according to an embodiment of the present invention.

FIG. 3 is a second schematic conceptual view of a generator utilizing an electric machine according to an embodiment of the present invention.

FIG. 4 is a third schematic conceptual view of a generator utilizing an electric machine according to an embodiment of the present invention.

### DETAILED DESCRIPTION

Hereinafter, preferred embodiments of the present invention will be described in detail with reference to the accompanying drawings. Advantages and features of the present invention, and methods for achieving them, will become clear with reference to the embodiments described below in detail together with the accompanying drawings. However, the present invention is not limited to the embodiments described herein but may be embodied in different forms. Rather, the embodiments introduced herein are provided so that the disclosed content will be thorough and complete, and the spirit of the present invention will be fully conveyed to those skilled in the art, and the present invention is only defined by the scope of the claims. Meanwhile, the same reference numerals refer to the same components throughout the specification.

The terminology used herein is for the purpose of describing the embodiments and is not intended to limit the present invention. In this specification, the singular forms also include the plural forms unless the context clearly indicates otherwise. As used in the specification, "comprises" and/or "comprising" does not exclude the presence or addition of one or more other components, steps, operations, and/or elements besides the mentioned components, steps, operations, and/or elements. Furthermore, since they are according to preferred embodiments, the reference numerals presented according to the order of description are not necessarily limited to that order. In addition, in this specification, when a certain component or part is mentioned, it does not mean that other components or parts are excluded, but rather that other components or parts may be additionally interposed if necessary.

The descriptions and examples provided herein are presented for illustrative purposes and are not intended to limit the scope of the appended claims. This specification should be considered as illustrating the principles of the present invention and is not intended to limit the claims of the described embodiments and/or the spirit and scope of the present invention. Those of ordinary skill in the art to which the present invention pertains will be able to modify the present invention for specific applications of the present invention.

In addition, the embodiments described in this specification will be described with reference to cross-sectional views and/or plan views, which are ideal illustrations of the present invention. In the drawings, the thicknesses of films and regions are exaggerated for effective description of technical content. Therefore, the form of the illustrations may be modified by manufacturing techniques and/or tolerances, etc. Accordingly, the embodiments of the present invention are not limited to the specific forms shown, but also include changes in form generated according to the manufacturing process. For example, an etching region shown at a right angle may be rounded or have a form with a certain curvature. Therefore, the regions illustrated in the drawings have schematic properties, and the shapes of the regions illustrated in the drawings are intended to illustrate specific forms of regions of the device and are not intended to limit the scope of the invention.

The technical problem to be achieved by the present invention is not limited to the technical problems mentioned above, and other technical problems not mentioned will be clearly understood by those of ordinary skill in the technical field to which the present invention belongs from the following description.

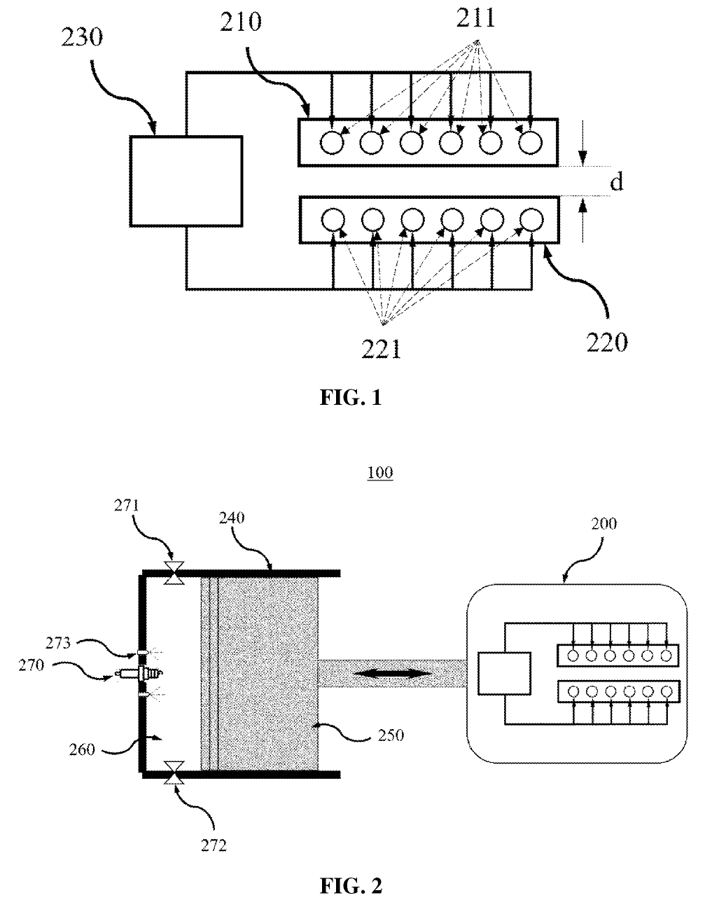

FIG. 1 is a block diagram of a linear motor among electric machines according to an embodiment of the present invention. In FIG. 1, a generator according to an embodiment of the present invention utilizes a multi-phase winding-active driving electric machine (200) including a stator (210), a mover (220), and a controller (230).

The stator (210) and the mover (220) of the multi-phase winding-active driving electric machine (200) include multi-phase windings (211, 221), respectively, and are formed to be spaced apart from each other by a predetermined interval (d). The controller (230) independently controls a first magnetic field of the stator (210) and a second magnetic field of the mover (220). A magnetic field is formed by controlling the direction of current flowing through the multi-phase windings, and the speed or direction of the magnetic field can be controlled by controlling the current flowing through the multi-phase windings.

The controller (230) may control the first magnetic field and the second magnetic field by controlling a first current applied to the multi-phase winding (211) of the stator (210) and a second current applied to the multi-phase winding (221) of the mover (220). In addition, the controller (230) may individually control the phase and amplitude of the first current and the second current according to the piston position and velocity to achieve optimal force generation and damping control throughout the stroke.

The controller (230) may control the first magnetic field of the stator (210) and the second magnetic field of the mover (220) to be mutually locked with each other at the initial stage of driving the electric machine (200). The controller (230) may control the moving directions of the first magnetic field and the second magnetic field to be the same direction or opposite directions.

The multi-phase windings (211, 221) arranged in a linear array may be applied to a linear generator/motor. In addition, the array may have a periodic arrangement structure and thus may also be applied to a rotating electric machine.

A small air gap exists between the stator and the mover, wherein the mover can move freely while maintaining a constant air gap relative to the stator. When a current flows through the multi-phase winding of the stator, a periodic magnetic field is generated within the air gap by the multi-phase winding of the stator. Similarly, when a current flows through the multi-phase winding of the mover, a periodic magnetic field is generated within the air gap by the multi-phase winding of the mover.

When the multi-phase winding of the stator is excited by a sinusoidal input current having an appropriate phase difference, a moving magnetic field is generated within the air gap; likewise, when the multi-phase winding of the mover is excited by a sinusoidal input current having an appropriate phase difference, a moving magnetic field is generated within the air gap.

When the mover moves at a constant speed relative to the stator, the moving magnetic field generated by the constant current flowing through the multi-phase winding of the mover moves as the mover moves. The sinusoidal current flowing through the multi-phase winding of the mover generates a moving magnetic field relative to the moving direction of the mover. When the mover moves, the moving magnetic field generated by the mover within the air gap moves at a speed determined by a combination of the speed of the moving magnetic field and the speed of the mover. That is, the speed of the magnetic field generated by the mover within the air gap is the sum or difference of the mover speed and the speed of the moving magnetic field.

The multi-phase windings constituting the stator and the mover include two or more individual windings, and said multi-phase windings generate a periodic magnetic field within the air gap when current flows. The multi-phase windings have a spatial period or cycle that is an integer multiple. In cases where there are two or more phase windings, the second winding is positioned offset by a fixed angle (phase distance) relative to the first winding. For example, in the case of a 2-phase winding, it may be shifted by 1/4 period (or an electrical angle of 90 degrees), and in the case of a 3-phase coil, it may be shifted by 1/6 period (or an electrical angle of 60 degrees).

By supplying current to the windings, the total magnetic field generated by all windings becomes the vector sum of the magnetic fields generated by the current flowing through each winding. At this time, the phase and amplitude of the total magnetic field can be changed by changing the phase and amplitude of the current flowing through the windings.

The number of spatial periods of the magnetic fields generated by the stator and the mover may be the same. The magnetic fields generated by the mover and the stator by their respective currents are controlled to maintain a mutual magnetic field locking state with each other. At this time, the magnetic field generated by the mover maintains a set phase relationship with the magnetic field generated by the stator, and they push or pull each other. As the phase of the current flowing through the multi-phase winding of the stator changes, the phase current of the mover changes while maintaining a set phase relationship with respect to the phase current of the stator. At this time, as the phase of the current of the stator changes, the magnetic field pattern generated by the stator moves within the air gap. As the magnetic field generated by the stator moves, the magnetic field generated by the mover moves together to maintain the field locking.

When the moving magnetic field by the stator and the moving magnetic field by the mover have opposite moving directions and the same moving speed, the mover moves at twice the moving speed of the magnetic field by the stator. Meanwhile, when the moving directions of the moving magnetic fields are the same and the moving speeds are the same, the mover maintains a stationary state.

If there is an external force pushing or pulling the mover in a direction opposite to the moving direction of the mover, mechanical power is transmitted to the mover. When the mover moves due to an external force, a small phase shift occurs in the current flowing through the multi-phase windings of the mover and the stator. The external force comes to balance with the force generated from the elements moving by the magnetic field and current.

By independently controlling the phase currents of the stator and the mover, the electric machine according to an embodiment of the present invention has a wide operating range and can reduce response time. In addition, compared to electric machines including permanent magnets, the electric machine according to an embodiment of the present invention can allow a larger current to flow, thereby generating greater force to produce higher output, and efficiency can also be optimized. Furthermore, the response speed is fast during the operation of the electric machine according to an embodiment of the present invention, making it easy to ensure safety.

A generator (100) including the electric machine according to an embodiment of the present invention is a generator capable of controlling a very large force without a gearbox. Additionally, since no physical gear exists, reliability is high and energy efficiency is also high.

FIG. 2 shows a first schematic conceptual view of an eco-friendly generator (100) in which a multi-phase winding-active driving electric machine (200) is integrated according to an embodiment of the present invention.

In FIG. 2, a cylinder (240) is provided within the generator (100). A piston (250) is inside the cylinder (240), and the piston (250) is slightly smaller than the internal diameter of the cylinder (240) but has a constant diameter such that the piston (250) moves freely in the axial direction of the cylinder (240). Meanwhile, the piston (250) is aligned coaxially with the cylinder (240). In addition, there is a combustion chamber (260) for combusting fuel at one side of the cylinder (240). The combustion chamber (260) has various volumes depending on the position of the piston (250) within the cylinder (240).

It is preferable that the cylinder (240) is symmetrical with respect to the movement axis of the piston (250). Although cylinders having potentially other geometric shapes, such as square or rectangular cross-section pistons, may be used to implement the present invention, an arrangement having circular cross-section pistons is preferred.

In the combustion chamber (260), an intake opening (271), an exhaust opening (272), and a spark plug (270) including a fuel injection device (273) are arranged at the end of the movement path of the piston (250). Meanwhile, the positions of the spark plug (270), the intake opening (271), the exhaust opening (272), and the fuel injection device (273) are indicated as examples to describe an embodiment of the present invention, and such arrangement is not limited thereto.

Meanwhile, the combustion chamber (260) may further include an oxidizer injection device (not shown) to omit a process of mixing fuel with air through air intake, thereby allowing the intake opening (271) to be excluded. In this case, the oxidizer includes oxygen and air, and the ratio of oxygen/air to fuel is adjusted by a controller according to the required output.

Meanwhile, the spark plug (270) according to an embodiment of the present invention may be replaced with an auto-ignition method depending on the fuel being injected.

Hereinafter, a power generation process for the eco-friendly generator (100) according to an embodiment of the present invention will be described by way of example, but this is not intended to limit the scope of the present invention.

The generator (100) according to an embodiment of the present invention is composed of two strokes: an intake/exhaust stroke and a compression/explosion/expansion stroke.

First, in the intake/exhaust stroke, as the piston (250) moves to the BDC (Bottom Dead Center, a state where the volume of the combustion chamber is at its maximum) of the combustion chamber (260) of the cylinder (240), the intake opening (271) and the exhaust opening (272) are opened to supply new air to the combustion chamber (260) and simultaneously discharge the combusted mixed air. At this time, in the eco-friendly generator (100) according to an embodiment of the present invention, the multi-phase winding-active driving electric machine (200) operates as a linear motor.

Next, in the compression/explosion/expansion stroke, the piston (250) propelled by the electric machine (200) moves to the TDC (Top Dead Center, a state where the volume of the combustion chamber is at its minimum) of the combustion chamber (260) to compress air, while the intake opening (271) and the exhaust opening (272) are closed and the air within the combustion chamber (260) is compressed. At this time, after compressing the air within the combustion chamber (260) using the electric machine (200) according to an embodiment of the present invention, fuel is injected into the combustion chamber (260) through the fuel injection device (273), and after the fuel and the oxidizer (air) are mixed, combustion of the mixture is initiated by the spark plug (270). Subsequently, the mixture within the combustion chamber (260) is combusted to generate heat and oxides, and the expansion caused by the heat and oxides within the combustion chamber (260) pushes the piston (250). At this time, the electric machine (200) according to an embodiment of the present invention operates as a generator to produce electricity until the expansion stops.

The fuel used in the eco-friendly generator (100) according to an embodiment of the present invention may include eco-friendly fuels such as bio-fuel and hydrogen, but is not limited thereto. In addition, depending on the fuel used in the eco-friendly generator (100) according to an embodiment of the present invention, the structure of the generator (100) described above may be partially modified, and the power generation operation process may also be modified accordingly.

Meanwhile, the eco-friendly generator (100) according to an embodiment of the present invention may further include a control means (not shown) capable of actively controlling the position and velocity of the piston (250), controlling the movement speed of the piston (250), an expected compression ratio of air and fuel, output, ignition timing, fuel injection timing, etc., which affect power generation efficiency.

That is, since the stator (210) and the mover (220) of the electric machine (200) according to an embodiment of the present invention are actively driven, the position and velocity of the piston can be actively controlled to optimize efficiency and achieve high output during power generation, and the TDC and BDC can be dynamically set for each stroke by controlling the speed and acceleration of the electric machine (200). The controller can determine the actual TDC position of the piston during the current stroke based on the magnetic field state or position sensors, and the compression ratio can be determined based on the TDC position since the compression ratio is directly related to the TDC position and the combustion chamber volume.

Furthermore, the ignition timing can be adjusted in coordination with the dynamically controlled compression ratio, and an ignition signal can be generated within a predetermined range before or after the TDC based on the compression ratio and operating conditions to increase the combustion efficiency of air and fuel. In addition, the fuel injection timing can be adjusted in coordination with the compression ratio and the ignition timing to further optimize the combustion process.

In addition, the electric machine (200) according to an embodiment of the present invention may operate as a motor performing linear reciprocating motion to store energy by compressing air using a free-piston engine, and may also produce electricity utilizing the stored compressed air. That is, eco-friendly renewable power may be used to store compressed air in a tank, and power may be supplied by generating electricity using the stored compressed air.

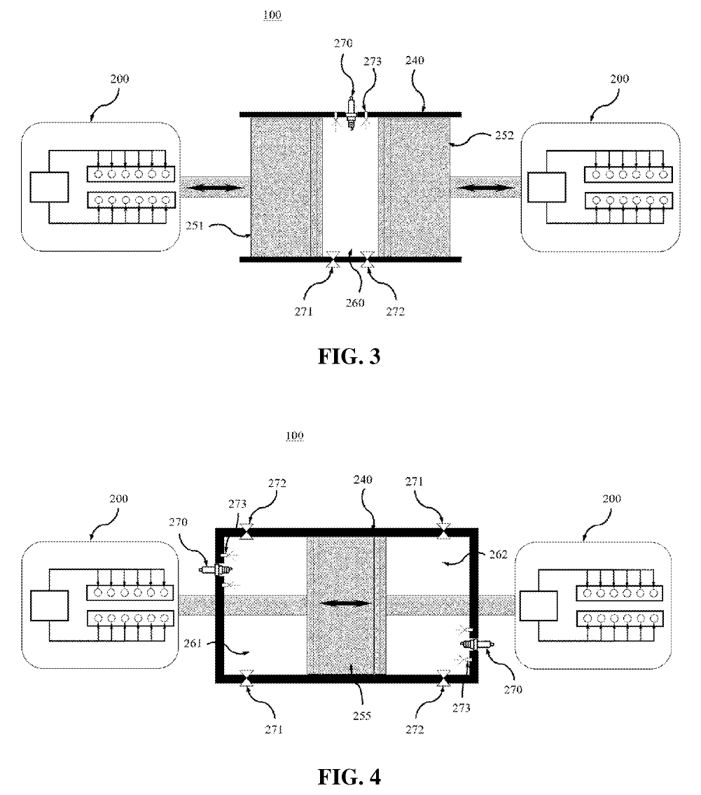

FIG. 3 shows a second schematic conceptual view of an eco-friendly generator (100) in which a multi-phase winding-active driving electric machine (200) is integrated according to an embodiment of the present invention.

In FIG. 3, opposed pistons (251, 252) are provided within a cylinder (240) inside the generator (100). The pistons (251, 252) are slightly smaller than the internal diameter of the cylinder (240) but have a constant diameter such that the pistons (251, 252) move freely along the length of the cylinder (240). Meanwhile, the pistons (251, 252) are aligned coaxially with the cylinder (240). Meanwhile, a combustion chamber (260) for combusting fuel is provided at the center of the cylinder (240). In the combustion chamber (260), an intake opening (271), an exhaust opening (272), and a spark plug (270) including a fuel injection device (273) are arranged. Meanwhile, the positions of the spark plug (270), the intake opening (271), the exhaust opening (272), and the fuel injection device (273) are indicated as examples to describe an embodiment of the present invention, and such arrangement is not limited thereto. Additionally, the spark plug (270) according to an embodiment of the present invention may be excluded in the case of auto-ignition.

The generator (100) according to an embodiment of the present invention operates similarly to the generator (100) of the first concept shown in FIG. 2. Meanwhile, the power generation operation process may also be modified depending on the fuel and structure used in the eco-friendly generator (100) according to an embodiment of the present invention.

FIG. 4 shows a third schematic conceptual view of an eco-friendly generator (100) in which a multi-phase winding-active driving electric machine (200) is integrated according to an embodiment of the present invention.

In FIG. 4, a single piston (255), in which dual pistons are combined, is provided within a sealed cylinder (240) inside the generator (100), with both ends coupled to electric machines (200). The piston (255) is slightly smaller than the internal diameter of the cylinder (240) but has a constant diameter such that the piston (255) moves freely along the length of the cylinder (240). Meanwhile, the piston (255) is coupled with separated combustion chambers (261, 262). Meanwhile, a mechanical interlocking device (not shown) may connect the two pistons to ensure symmetrical piston behavior.

The generator (100) according to an embodiment of the present invention operates in a manner similar to the previously described methods. Meanwhile, the power generation operation process may also be modified depending on the fuel and structure used in the eco-friendly generator (100) according to an embodiment of the present invention.

Meanwhile, such an opposed piston method is advantageous in terms of system balance and vibration compared to other types of free-piston engines, and since there is no cylinder head, heat transfer loss is reduced, thereby allowing for high scavenging efficiency.

What is claimed is:

1. A linear generator comprising:
an electric machine; and an internal combustion engine,
wherein the electric machine comprises:
a stator including multi-phase windings;
a mover including multi-phase windings and spaced apart from the stator by a predetermined interval; and
a controller configured to independently control a first magnetic field of the stator and a second magnetic field of the mover,
wherein the controller is configured to actively control a position and a velocity of the piston to optimize efficiency and achieve high output during a power generation process,
wherein the controller is configured to:
dynamically control a compression ratio by independently controlling the magnetic fields of the stator and the mover to variably adjust a Top Dead Center (TDC) position of a piston for each stroke;
in coordination with the dynamic compression ratio:
determine a TDC position of a current stroke,
adjust an ignition timing corresponding to the compression ratio, and
generate an ignition signal within a predetermined range before or after the TDC; and
electronically generate a repulsive force and a damping force of the piston without physical springs and dampers by adjusting a phase and an amplitude of currents applied to the stator and the mover according to a piston position and a piston velocity to variably apply damping forces during compression and expansion strokes.

2. The linear generator of claim 1,
wherein the controller is further configured to:
determine the compression ratio based on the TDC position of the piston, and
adjust a fuel injection timing in coordination with the compression ratio and the ignition timing.

3. The linear generator of claim 1,
wherein adjusting the phase and the amplitude of the currents comprises:
controlling a phase difference between the first current applied to the stator and the second current applied to the mover to generate the repulsive force, and
controlling an amplitude of the first current and the second current to adjust a magnitude of the damping force.

4. The linear generator of claim claim 1,
wherein the combustion chamber includes at least one opening.

5. The linear generator of claim 4,
wherein the opening includes at least one intake opening.

6. The linear generator of claim 4,
wherein the opening further includes at least one oxidizer injection device.

7. The linear generator of claim 4,
wherein the opening includes at least one exhaust opening.

8. The linear generator of claim 1,
wherein the combustion chamber includes at least one spark plug.

9. The linear generator of claim 8,
wherein the spark plug further includes at least one fuel injection device.

10. The linear generator of claim 1,
wherein the controller is further configured to:
determine a Bottom Dead Center (BDC) position of the piston for each stroke, and
control a stroke length by adjusting both the TDC position and the BDC position.

11. The linear generator of claim 1,
wherein the piston comprises a pair of pistons,
wherein the combustion chamber is defined by a space formed by the cylinder and the pair of pistons, and
wherein each of the pair of pistons is coupled to the electric machine at one end distal to the combustion chamber.

12. The linear generator of claim 11,
wherein the combustion chamber is disposed between the pair of pistons.

13. The linear generator of claim 12,
wherein a volume of the combustion chamber decreases as the pair of pistons approach each other and increases as the pair of pistons move away from each other.

14. The linear generator of claim 1,
wherein the piston has a structure in which two pistons are combined into a single piston structure.

15. The linear generator of claim 14,
wherein the combustion chamber comprises two combustion chambers separated by the piston.

16. The linear generator of claim 15,
wherein a volume of one combustion chamber increases and a volume of the other combustion chamber decreases according to a movement direction of the piston.

17. The linear generator of claim 15,
wherein each of the two separated combustion chambers includes at least one opening.

18. The linear generator of claim 1,
wherein the internal combustion engine comprises:
at least one cylinder,
at least one piston coaxially aligned with the cylinder and moving within the cylinder, and
at least one combustion chamber configured to combust fuel within a space formed by the piston and the cylinder.

19. The linear generator of claim 1,
wherein the internal combustion engine is configured to operate with multiple types of fuel including compressed air, bio-fuel, hydrogen, and gasoline.
